(19) United States
(12) Patent Application Publication
(10) Pub. No.: US 2014/0102374 A1
(43) Pub. Date: Apr. 17, 2014

(54) Pump Anchored Fountain Cover And Pet Fountain Assembly

(71) Applicant: PIONEER PET PRODUCTS, LLC, Cedarburg, WI (US)

(72) Inventors: John M. Lipscomb, Cedarburg, WI (US); Qing He, North Andover, MA (US)

(73) Assignee: Pioneer Pet Products, LLC, Cedarburg, WI (US)

(21) Appl. No.: 13/653,006

(22) Filed: Oct. 16, 2012

(51) Int. Cl. A01K 7/00

(52) U.S. Cl. 119/74

(57) ABSTRACT

A recirculating pet fountain has a cover anchored in a basin by attachment to a pump mounted to the basin. The cover includes a spillway having opposite side edges slidably conforming to the inner surface of opposite adjacent sides of a basin sidewall helping locate the cover during assembly preventing side-to-side cover movement after assembly. The spillway rests on a bottom of the basin and has a bottom edge spaced from the bottom defining an intake leading to the pump. The cover can include a support spaced from the spillway configured to hold a filter with the support resting on the basin bottom. A cord anchor can be integrally formed in the basin sidewall to hold part of a pump power cord in a manner enabling the cover to rest thereon. Such a fountain assembly enables the cover to be anchored within the basin without interlockingly engaging the basin.

### FIELD

The present invention relates generally to a pet watering device and more particularly to a recirculating pet fountain.

### BACKGROUND

Recirculating pet water fountains are very popular as recirculating water helps keep water from getting stale, is appealing to many types of pets, and provides a pet owner a sense of satisfaction that they are making the life of their pet better. While recirculating pet water fountains have enjoyed substantial commercial success, improvements nonetheless remain desirable.

Commercially available pet water fountains typically come unassembled requiring the purchaser to put them together. In the past, unassembled pet water fountains contained so many parts; it was much like putting together a complicated three dimensional jigsaw puzzle. In addition to being a daunting task to put them together, it was no less of a daunting task later on to take them apart when it became necessary to clean the fountain.

While attempts have been made to reduce the number of parts a fountain requires, it has not been without considerable challenge. Many times the attempt to reduce the number of parts comes with a tradeoff in aesthetic appearance as fountains with fewer parts often look cheaper and have a far less aesthetically pleasing appearance.

What is desired is a fountain having a minimum number of parts which fit together to produce a recirculating pet fountain having an aesthetically pleasing appearance.

### SUMMARY

The present invention is directed to a pet watering device of simple construction formed of a minimum of parts that produces an aesthetically pleasing pet watering device formed of a basin, a pump attached to the basin, and a cover attached to the pump. In a preferred embodiment, the cover is received in the basin with the cover anchored in the basin solely by attachment to the pump which is attached to the basin. Such a preferred pet watering device produces a recirculating pet fountain where the cover is located relative to the basin and anchored in the basin without engaging the basin.

The basin includes a bottom from which a sidewall bounding the bottom upwardly extends defining a water-holding bowl. The pump has an discharge tube that couples with a water transport tube of the cover anchoring the cover in the basin via coupling with the pump mounted in the basin with the coupling enabling water from the pump to flow through the water transport tube down the cover into the basin.

The cover has a spillway extending downwardly toward the basin bottom along which water from the pump flows into an open drinking well formed between the cover and basin. The spillway can rest on the basin bottom further supporting the cover thereon in addition to the cover being coupled to the pump. The cover can also include a support extending downwardly from an inner surface of the cover that rests on the basin bottom supporting the cover thereon. The support can be in the form of a wall that can include a filter holder releasably receiving and retaining a water filter located between the pump and the spillway. A preferred spillway defines an intake with part of the basin that preferably is part of the basin bottom with the filter holder positioning the filter between the intake and pump so water from the open drinking well entering the intake is filtered by the filter before being pumped by the pump.

The pump is received in a pump seat formed in the basin underlying the cover with the pump having an electrical power cord received in a cord strain relief integrally formed of the basin with part of the cord extending from the cord strain relief into the basin providing a cover rest upon which part of the cover can be supported. A preferred strain relief includes a mouth of a slot integrally formed in the basin sidewall in which the cord seats holding the cord and helping to more securely anchor the pump in the basin.

A preferred cover has a spillway inclined downwardly toward the basin bottom that includes a plurality of spaced apart feet that rest on the basin bottom with a bottom edge of the spillway spaced from the bottom defining an intake through which water in the basin flows toward the pump. A preferred spillway has a pair of feet spaced apart by the bottom spillway edge defining the intake therebetween.

Where equipped with a filter holder, the filter holder can be formed of a support wall divided by the filter into a pair of legs that each can rest on the basin bottom. The filter holder includes a pair of generally parallel, opposed and generally vertically extending filter-edge receiving channels. The filter-holding support wall extends from one side of the basin sidewall to the other side of the basin sidewall directing water flowing through the intake toward the filter so the water is filtered before reaching the pump.

Both the spillway and filter holder extend from one side of the basin sidewall to the other side of the basin sidewall helping to locate the cover in the basin without engaging the basin thereby also helping to prevent side-to-side movement of the cover relative to the basin. The cover can include a cover locator extending in a direction opposite the spillway to the basin sidewall having a cover locator edge that conforms to part of the inner surface of the basin sidewall enabling the cover locator to abut against the basin sidewall without engaging the basin. Such a cover locator can be curved such as by being semi-circular conforming to a generally curved portion of the basin sidewall that can also be semi-circular.

A preferred embodiment of a pet fountain constructed in accordance with the present invention has a pump attached to the basin bottom, such as by being received in a pump seat of the basin bottom, with the pump having an electrical power cord received in a cord strain relief integrally formed in the basin sidewall upon which part of a cover attached to the pump rests. The pump has a discharge tube telescopically coupling with a water transport tube of the cover during attachment of the cover to the pump that is mounted in the basin. When attached to the pump, a spillway of the cover extends downwardly toward the basin bottom with part of the spillway resting on the basin bottom and another part of the spillway defining an intake with the basin bottom that is in liquid flow communication with the pump. The cover can include a support extending downwardly between the pump and spillway that rests on the basin bottom helping to support the cover thereon. Such a support can be a support wall extending from one side of the basin sidewall to an opposite side of the basin sidewall with the support wall also including an integrally formed filter holder formed therein that removably receives a disposable water filter disposed between the intake and pump so water from the intake is filtered before entering the pump.

These and other objects, features and advantages of this invention will become apparent from the following detailed description of the invention and accompanying drawings.

### DRAWING DESCRIPTION

One or more preferred exemplary embodiments of the invention are illustrated in the accompanying drawings in which like reference numerals represent like parts throughout and in which:

FIG. 1 is top perspective view of a preferred embodiment of a recirculating pet fountain constructed in accordance with the present invention;

FIG. 2 is a top plan view of the fountain of FIG. 1.

FIG. 3 is a side elevation view of the fountain of FIG. 1;

FIG. 4 is an exploded view of the fountain of FIG. 1;

FIG. 5 is a longitudinal cross-section view of the fountain of FIG. 1 depicting a fountain cover received in a fountain basin and anchored in the basin by the pump;

FIG. 6 is a top plan view of the fountain basin with the cover removed showing the pump seated in the basin and the pump power cord seated in a cord strain relief integrally formed in a sidewall of the basin;

FIG. 7 is a partial fragmentary elevation view of part of the basin sidewall showing insertion of the pump power cord into a mouth of the cord strain relief;

FIG. 8 is a partial fragmentary elevation view of part of the basin sidewall depicting the power cord frictionally retained in a cord seat of the cord strain relief securing the cord to the basin sidewall;

FIG. 9 is a top front perspective view of the fountain cover with the basin shown in phantom;

FIG. 10 is a front elevation view of the fountain cover of FIG. 9 showing the basin in phantom;

FIG. 11 is a rear elevation view of the fountain cover of FIG. 9 showing the basin in phantom;

FIG. 12 is a bottom plan view of the fountain cover of FIG. 9;

FIG. 13 is a side elevation view of the fountain cover of FIG. 9; and

FIG. 14 is a cross-sectional view of the fountain cover taken along line 14-14 of FIG. 9.

Before explaining one or more embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

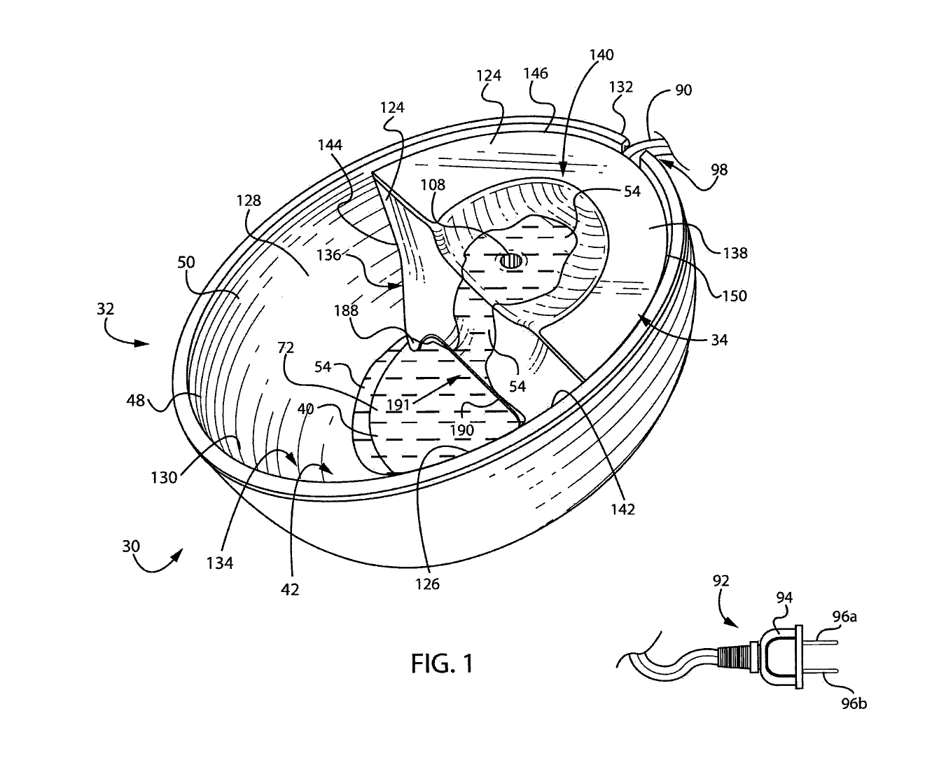

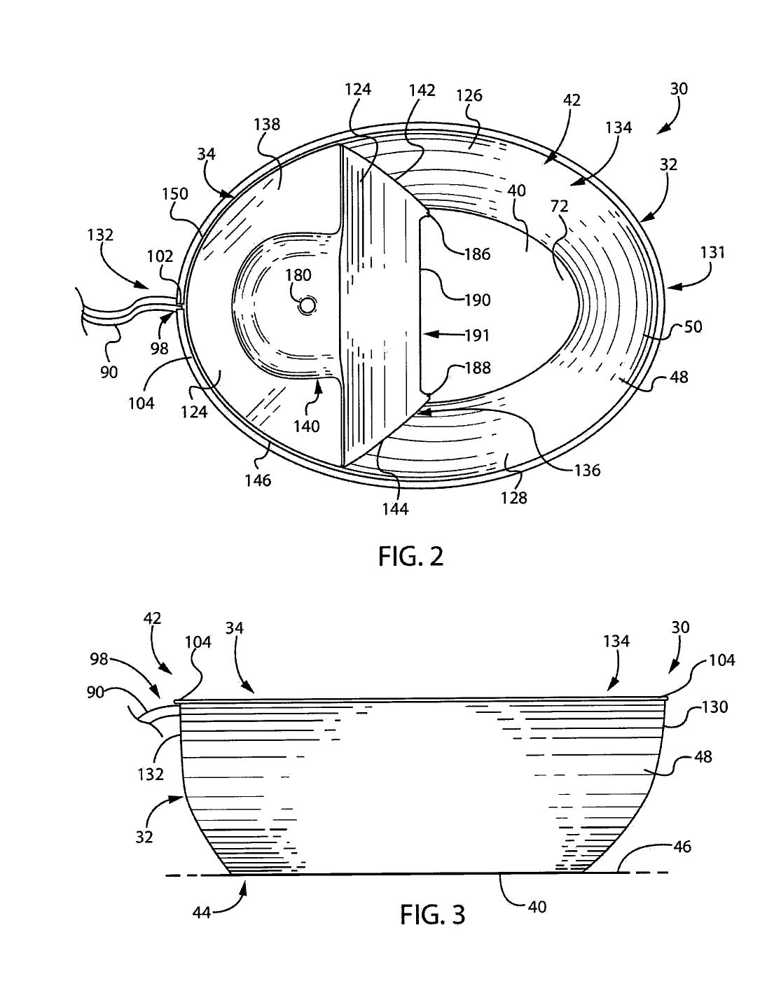

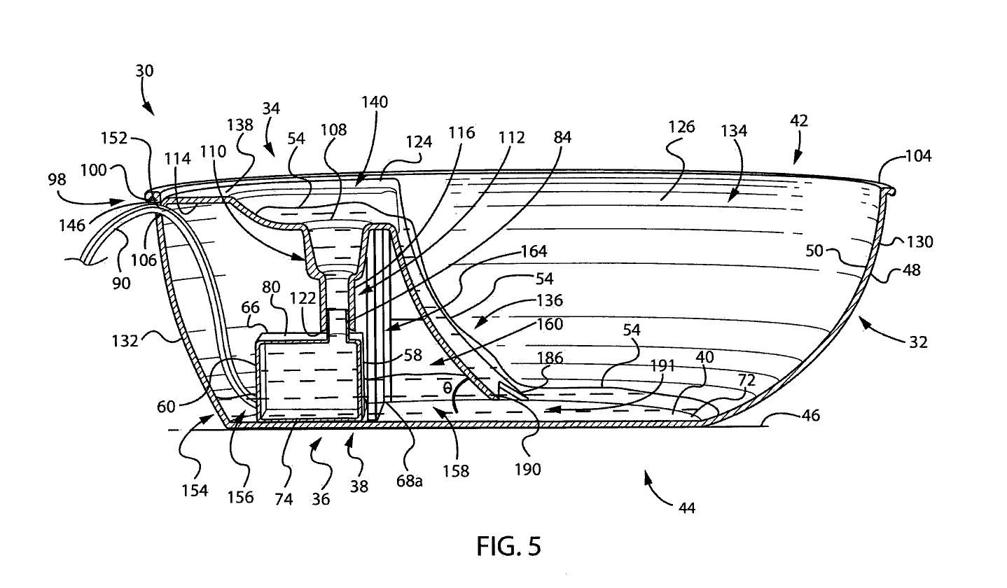

FIGS. 1-5 illustrate a preferred embodiment of a recirculating pet fountain 30 that is a watering device or waterer for a pet, such as a cat, dog or the like. The fountain 30 has a basin 32 in which a cover 34 enclosing a pump 36 is received with the cover 34 releasably but securely anchored in the basin 32 by the pump 36. As is best depicted in FIG. 5, the pump 36 functions as a cover anchor 38 that removably attaches to a bottom 40 of the basin 32 and which releasably couples with the cover 34 removably anchoring the cover 34 in the basin 32. When the pump 36 is attached to the basin 32 and the cover 34 is attached to the pump 36, the cover 34 is substantially immovably anchored in place in the basin 32 by the pump 36.

The fountain basin 32 is a bowl 42 having a bottom 40 that can be flat and which defines a base or pedestal 44 upon which the fountain 30 rests on a generally flat surface 46, like that shown in FIG. 5, which can be a generally flat floor, countertop, the ground, or another generally flat surface. The basin 32 includes a sidewall 48 of endless construction that extends upwardly from the bottom 40 about entire periphery of the bottom 40. The basin 32 is an open bowl 42 defined by the endless basin sidewall 48 extending upwardly from the bottom 40.

The basin sidewall 48 has an inner surface 50 that can be smooth and uninterrupted that preferably is substantially uninterrupted along where the cover 34 adjoins the sidewall 48 when received in the basin 32 and anchored to the basin 32 by the pump 36. The basin bottom 40 and sidewall 48 form a generally circular open bowl 42 that can be oval with the sidewall 48 having a curved transverse cross-section curved about or along at least one radius of curvature as depicted in FIGS. 1-5. The basin bottom 40 has an inner surface 72 that can also be substantially flat as depicted in FIGS. 1-5. The basin bottom 40 and sidewall 48 define a bowl 42 that holds water 54 that is recirculated by the pump 36 during fountain operation.

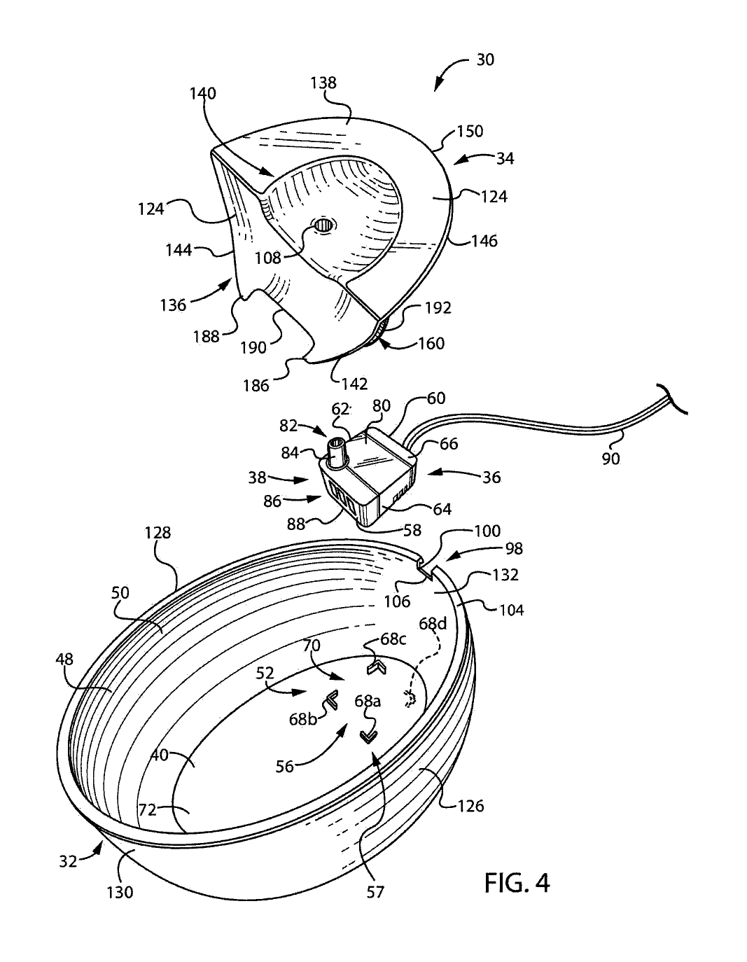

With reference to FIGS. 4-6, the basin 32 includes an integrally formed pump seat 52 in which the pump 36 is seated during fountain assembly. The pump seat 52 is constructed and arranged to locate the pump 36 during attachment of the pump 36 to the basin 32. The pump seat 52 is also constructed and arranged to cooperate with a pump 36 mounted to the basin 32 to help prevent the pump 36 from substantially moving relative to the seat 52, including when the cover 34 is mounted to the pump 36, during use and operation of the fountain 30. Such a pump seat 52 is a three dimensional structure 56 integrally formed of the basin 32.

A preferred pump seat 52 is a three dimensional cradle arrangement 57 configured to support at least a plurality of sides 58, 60, 62 and/or 64 of an outer housing 66 of the pump 36. A preferred pump seat 52 is a three dimensional cradle arrangement 58 configured to support at least a plurality of pairs, i.e., at least three, of sides 58, 60, 62 and/or 64 of the pump housing 66. While the cradle arrangement 57 can extend about substantially the entire outer periphery of sides 58, 60, 62 and 64 of the pump 36 that define a generally rectangular, e.g., square, or generally cube-shaped outer pump housing 66, a preferred cradle embodiment is formed of a plurality of spaced apart cradles 68a, 68b, and 68c that each adjoin or bracket at least one and preferably a plurality of pump housing sides 58, 60, 62 and 64.

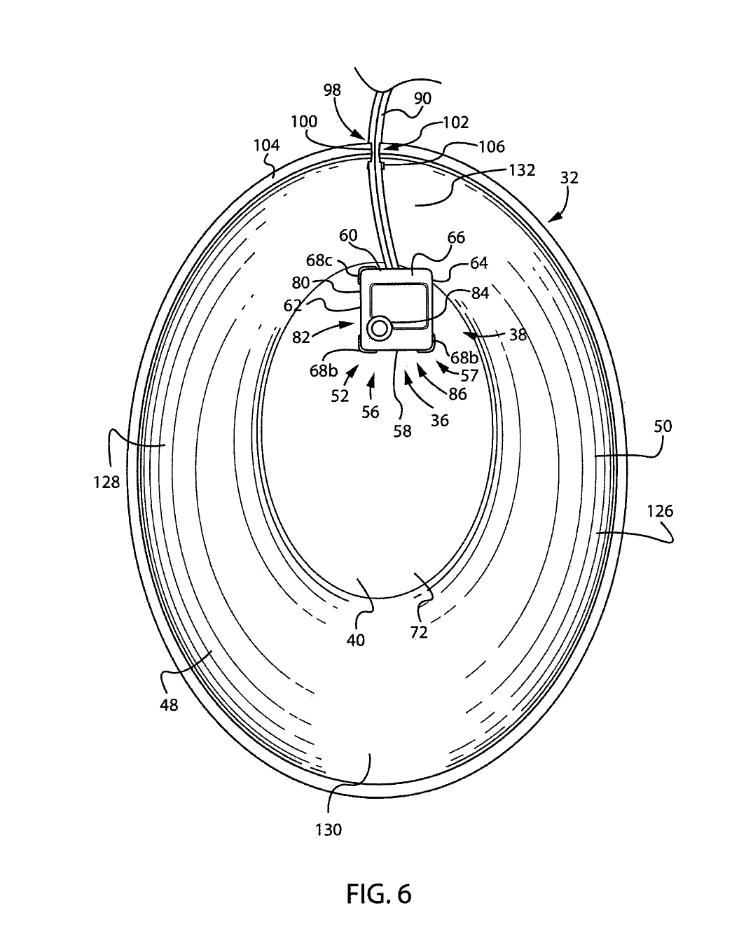

FIG. 4 illustrates a preferred pump seat embodiment that includes a plurality of generally L-shaped pump seat cradles 68a, 68b, and 68c that each bracket a corresponding corner of the pump housing 66 formed where each pair of pump housing sides 58, 60, 62 and 64 converge to form a respective pump corner. Such a pump seat 52 includes at least a pair of generally L-shaped pump seat cradles 68a and 68c or 68b and 68d that bracket opposite corners of the housing 66 of a pump 36 seated in the seat 52. A preferred pump seat 52 has at least three generally L-shaped cradles 68a, 68b, and 68c that bracket a plurality of pairs of corners of the pump housing 66, such as in the manner depicted in FIGS. 4 and 6. If desired, the seat 52 can include a fourth seat 68d, shown in phantom in FIG. 4, so producing a pump seat arrangement that cradles all four corners of the housing 66 of a pump 36 seated in the seat 52. The cradles 68a, 68b, 68c and/or 68d can extend about and define a pump seat well 70, such as depicted in FIG. 4, which can be recessed below an inner surface 72 of the basin bottom 40 with each one of the cradles 68a, 68b, 68c and/or 68d extending upwardly from the basin bottom inner surface 72.

The housing 66 of the pump 36 has a bottom wall 74 from which at least one and preferably a plurality of resilient mounts 76, 78 downwardly extend that are used to attach the pump 36 to the basin 32 in the pump seat 52. Each one of the resilient mounts 76, 78 can be or otherwise include an elastomeric suction cup. The pump 36 has a top wall 80 that includes a tubular liquid-conveying pump discharge outlet 82 that preferably is a pump discharge tube 84. One of the pump housing sides 58 includes a pump intake 86 that can be in the form of a perforate intake grate 88 integrally formed in the pump housing side 58. When the pump 36 is received in the seat 52 in the basin 32, water in the basin 32 is drawn into the pump intake 86 and discharged by the pump 36 out its discharge tube 84 during operation.

The pump 36 is an electrically powered pump that preferably is a submersible pump, such as a magnetic impeller driven aquarium pump. The pump 36 has a housing 66 made of plastic with the pump 36 preferably being of dishwasher safe construction. The pump 36 includes an elongate two-conductor electrical cord 90 extending from the pump housing 66 to which an electrical connector 92 that can be a plug 94 having a pair of spaced apart prongs 96a, 96b configured to be plugged into a socket of an electrical outlet of an utility electric power source having a voltage of at least 110 volts AC. If desired, the cord 90 can electrically connect to a transformer or the like which in turn can be electrically connected to such a utility electric power source.

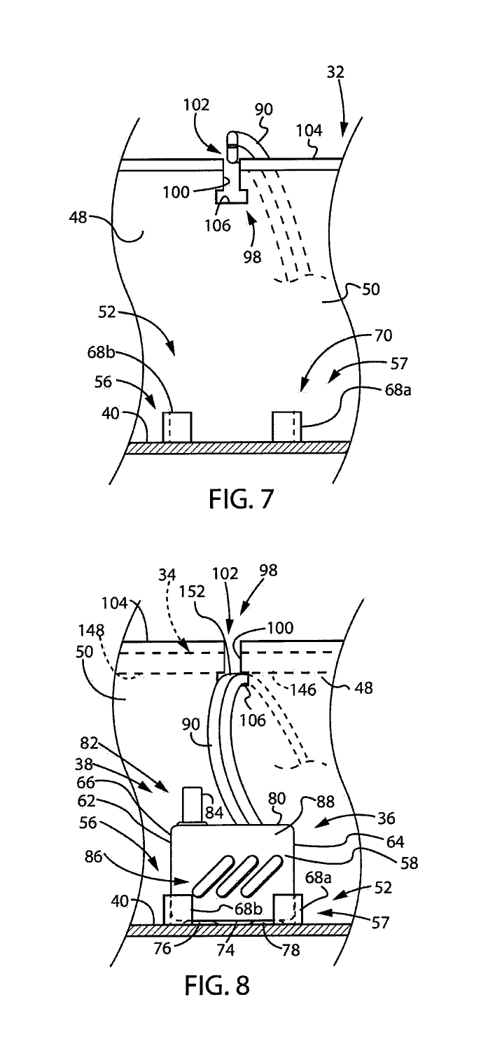

With additional reference to FIGS. 6 and 7, to more securely and more immovably anchor the pump 36 to the basin 32, the pump electrical cord 90 is received in a cord strain relief 98 integrally formed of part of the basin 32 that functions as a cord anchor. By more securely and substantially immovably anchoring the pump 36 in place by anchoring its cord 90 to the basin 32 when seated in pump seat 52, the cover 34 is advantageously more securely and more immovably anchored to the basin 32 by the pump 36. The cord strain relief 98 is formed of a generally upside-down T-shaped slot 100 that has a mouth 102 formed in a top or outer edge 104 of the basin sidewall 48 that extends downwardly in the sidewall 48 toward the basin bottom 40 communicating with a generally horizontally extending cord seat 106 in which the cord 90 is secured when completely inserted into the cord strain relief slot 100. When the cord 90 is received in the seat 106, a friction fit preferably is formed between the cord 90 and part of the basin sidewall 48 forming the cord strain relief 98 substantially immovably holding the cord 90 in the seat 106.

The cord strain relief 98 is located rearward of and above the housing 66 of the pump 36 when the pump 36 is received in the pump seat 52 minimizing the length of the cord run of the pump power cord 90 from the strain relief 98 to the pump 36. Minimizing the length of the cord run of the cord 90 from the strain relief 98 in which the cord 90 is securely anchored makes the cord 90 extending between the strain relief 98 and pump seat 52 relatively stiff helping to more firmly and securely retain the pump 36 in the seat 52. Such a configuration can result in the length of cord 90 between the cord strain relief 98 and pump 36 urging the pump 36 more firmly into its seat 52. Doing so causes part of the pump housing 66 to more securely and hence more immovably abut against one or more of the pump seat cradles 68a, 68b and/or 68c bracketing corners of the pump 36. When the cover 34 is mounted to the pump 36 with the pump 36 is received in the pump seat 52 and the cord 90 anchored in the cord strain relief 98, the cover 34 is more securely and substantially immovably mounted within the basin 32 to the pump 36.

When the pump 36 is mounted in the pump seat 52 and the pump cord 90 received in the cord seat 106 of the cord strain relief 98, the cover 34 is configured to releasably attach to the pump 36 in a manner that not only substantially immovably anchors the cover 34 in the basin 32, it also does so in a manner that enables water discharged from the pump 36 to be directed by the cover 34 back into the basin 32 during substantially continuous recirculation of water 54 by the pump 36 during fountain operation. As is best shown in FIG. 5, the cover 34 has an outlet opening 108 in fluid-flow communication with a liquid-conveying conduit 110 of the cover 34 that defines a cover-anchoring pump coupling 112 with the discharge tube 84 of the pump 36 generally fluid-tightly coupling the cover 34 to the pump 36. When the pump 36 is seated in the seat 52 of the basin 32, engagement of the liquid-conveying conduit 110 of the cover 34 with the discharge tube 84 of the pump 36 not only properly locates the cover 34 relative to the basin 32 and the pump 36, it also anchors the cover 34 in the basin 32 via its attachment to the pump 36. In a preferred embodiment, frictional engagement between the liquid-conveying conduit 110 of the cover 34 and the discharge tube 84 of the pump 36 help anchor the cover 34 to the pump 36 thereby helping to anchor the cover 34 in the basin 32 via its attachment to the pump 36. Such a substantially fluid-tight coupling between the cover 34 and pump 36 enables the cover 34 to be attached to the pump 36 and be anchored in the basin 32 without engaging the basin 32 including without interlocking engagement or snap-fit engagement.

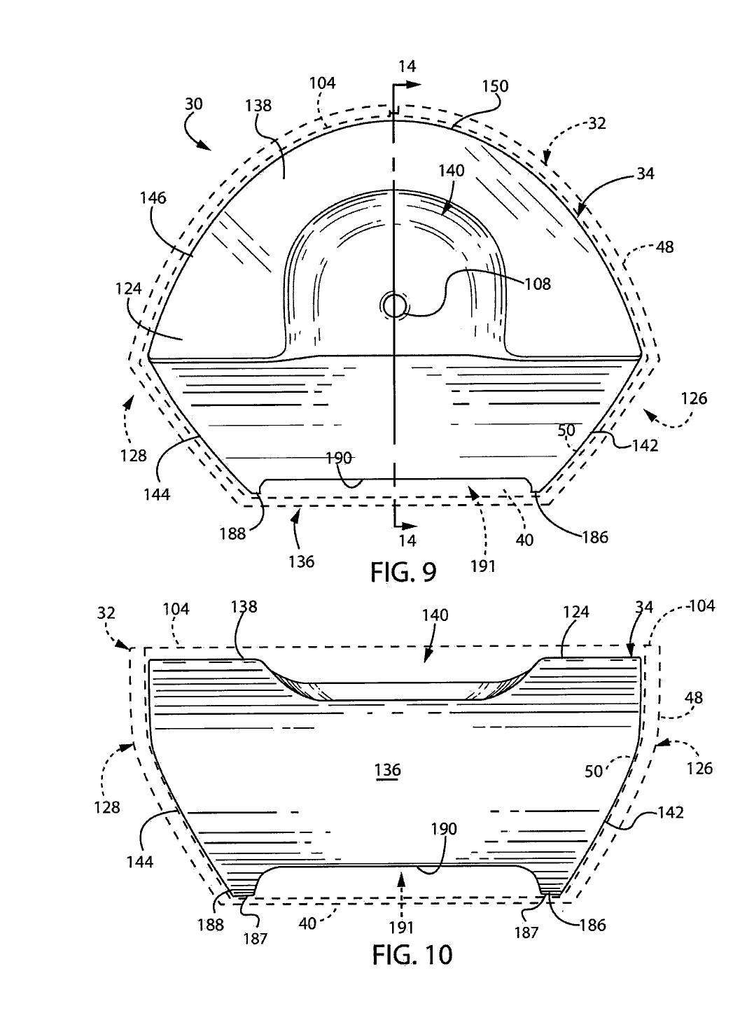

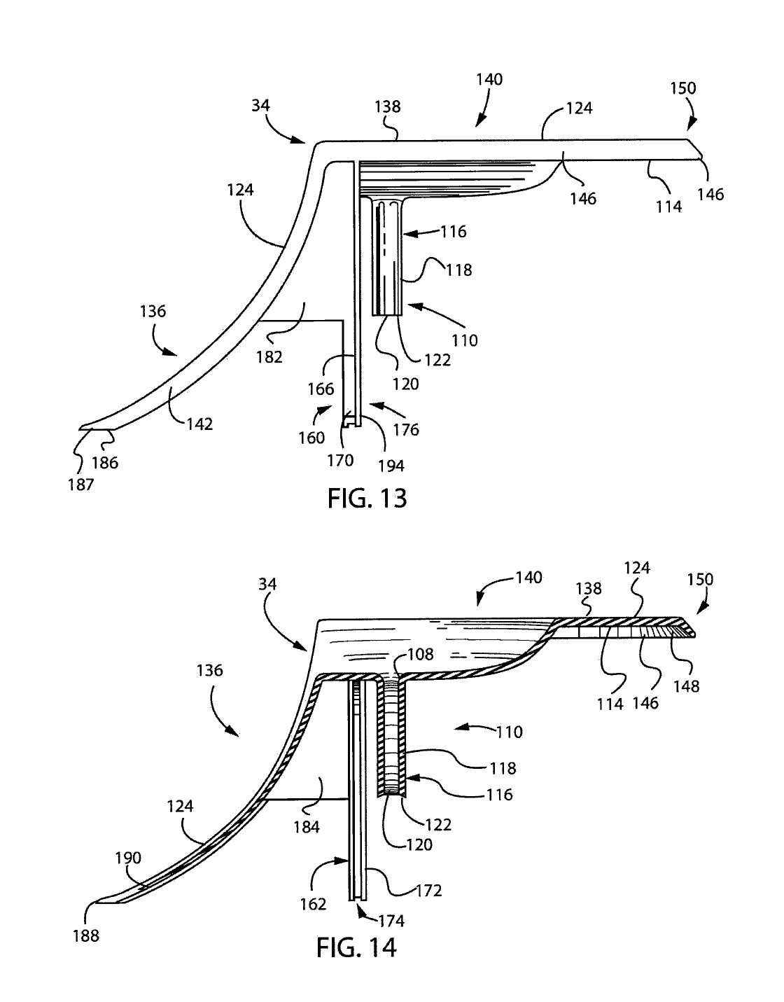

With additional reference to FIGS. 9-14, the liquid-conveying conduit 110 of the cover 34 includes a water transport tube 116 defined by an endless tube sidewall 118 that can be elongate and which has an inlet opening 120 that telescopically couples with the discharge tube 84 of the pump 36 when the cover 34 is attached to the pump 36. As best shown in FIG. 5, a preferred cover-anchoring pump coupling 112 is configured so the generally cylindrical discharge tube 84 of the pump 36 has an outer diameter no greater than the inner diameter of the generally cylindrical water transport tube 116 of the cover 34 at the inlet opening 120 enabling the pump discharge tube 84 to be telescopically received through the inlet opening 120 in the water transport tube 116 of the cover 34.

To help guide the tubes 84 and 116 into such telescopic coupling and engagement, the free end of the water transport tube 116 of the cover 34 has an outer axial edge 122 that is inclined toward the inlet opening 120 forming a chamfer about the opening 120 that facilitates “docking” of the pump discharge tube 84 with the water transport tube 116 during attachment of the cover 34 to the pump 36. The chamfered outer edge 122 of the water transport tube 116 of the cover 34 accommodates slight axial and angular misalignment(s) with the free end of the pump discharge tube 84 as the cover 34 and pump 36 are brought together during fountain assembly by slidably urging and thereby guiding the end of the pump discharge tube 84 toward and into the inlet opening 120 of the water transport tube 116. When attachment is completed, part of the pump discharge tube 84 is telescopically received in part of the water transport tube 116 providing a substantially fluid-tight coupling therebetween that releasably couples the cover 34 to the pump 36.

With reference to FIGS. 1, 2, 5, and 9-11, the cover 34 is received in the basin bowl 42 and anchored to the basin 32 by the pump 36. The cover 34 extends from one side 126 of the basin 32 to the opposite side 128 of the basin 32 from at or adjacent the basin bottom 40 to either the front 130 or rear 132 of the basin 32 covering part of the basin bowl 42 enclosing the pump 36 and defining an open drinking well 134 where the basin 32 is not covered by the cover 34. In the preferred fountain embodiment shown in the drawing figures, the cover 34 extends from side-to-side when received in the basin bowl 42 extending between opposite sides 126 and 128 of the basin sidewall 48 from the basin bottom 40 to the rear 132 of the basin sidewall 48.

As is shown in FIGS. 1 and 4, the cover outlet opening 108 is formed in an outer surface 124 of the cover 34 with the outlet opening 108 being in liquid flow communication with the open drinking well 134 of the fountain 30 such that water 54 discharged by the pump 36 exits the opening 108 and then flows from the cover 34 into the drinking well 134 enabling a pet to drink from water in the well 134. The cover 34 includes a spillway 136 extending from at or adjacent the cover outlet opening 108 generally downwardly to or adjacent the bottom 40 of the basin 32 enabling water 54 discharged from the opening 108 to flow down the spillway 136 into the open drinking well 134 below. A pet can also drink water 54 as it is flowing down the spillway 136 into the drinking well 134.

The fountain cover 34 can include an outer or top wall 138 extending from the spillway 136 rearwardly toward the rear 132 of the basin 32. The top wall 138 of the cover 34 can include an upper bowl 140 integrally formed therein in which the outlet opening 108 can be located enabling water 54 discharged from the pump 36 to exit from the outlet opening 108 into the upper bowl 140 before flowing down the spillway 136 into the open drinking well 134 below. The upper bowl 140 is formed of a recess in the outer surface 124 of the top wall 138 of the cover 34 that can be configured to hold at least some water 54 discharged from the outlet opening 108 enabling a pet to drink from water 54 in the upper bowl 140.

The outer surface 124 of the spillway 136 is inclined relative to the basin bottom 40 and can be concavely curved, such as is depicted in FIG. 5, enabling water 54 to more smoothly flow down the spillway 136 into water 54 in the open drinking well 134. With continued reference to FIG. 5, the spillway 136 is inclined at an acute included angle, θ, with the basin bottom 40 that is less than 60° and preferably between 15° and 50° to help encourage smooth substantially laminar flow of water 54 down the spillway 136 into the open drinking well 134. The spillway 136 can also be concavely curved about a radius of curvature such that the outer surface 124 of the spillway 136 is concavely curved about a radius of curvature having an end or endpoint (not shown) disposed outwardly of the spillway 136 and outwardly of the open drinking well 134. Imparting such a concave curvature to the outer surface 124 of the spillway 136 down which water 54 flows during fountain operation also helps encourage generally laminar water flow.

The spillway 136 extends from one side 126 of the basin sidewall 48 to the other side 128 of the basin sidewall 48 thereby helping to prevent side-to-side movement of the cover 34 when mounted by the pump 36 to the basin 32. In addition to helping prevent side-to-side movement, extension of the spillway 136 from one side 126 of the basin sidewall 48 to the other side 128 of the basin sidewall 48 also helps locate the cover 34 in the basin 32 and helps support the cover 34 in the basin 32.

The spillway 136 is defined by a pair of elongate spaced apart side edges 142, 144 with one of the side edges 142 extending along one side 126 of the basin sidewall 48 and the other one of the side edges 144 extending along the other side 128 of the basin sidewall 48, such as depicted in FIGS. 1, 2 and 6. Each spillway side edge 142, 144 is curved so it substantially conforms to the contour of the inner surface 50 of a corresponding side 126, 128 of the basin sidewall 48 such that each side edge 142, 144 abuts or adjoins the inner surface 50 of the respective side 126, 128 of the sidewall 48 helping to prevent side-to-side cover movement.

The top wall 138 of the cover 34 has an outer edge 146 extends from one side of the spillway 136 to the other side of the spillway 136 with the outer edge 146 preferably extending from a top portion of one spillway side edge 142 to the top portion of the other spillway side edges 144. The outer edge 146 of the cover top wall 138 can include a downturned lip 148 like that best shown in FIG. 14. The outer edge 146 extends along the inner surface 50 of the basin sidewall 48 from one side 126 to the other side 128 and along the rear 132 of the basin sidewall 48. The outer edge 146 is curved so as to substantially conform to the portion of the inner surface 50 of the curved basin sidewall 48 extending from one side 126 along the rear 132 to the other side 128.

The outer edge 146 of the top wall 138 of the cover 34 defines a semi-circular cover locator 150 that substantially conforms to the semi-circular inner surface 50 of the basin sidewall 48 that extends along the rear 132 of the sidewall 48 from at or adjacent one side 126 to or adjacent the other side 128 of the sidewall 48 adjacent or along the top edge 104 of the sidewall 48. When the cover 34 is mounted by the pump 36 in the basin 32, the semi-circular cover locator 150 formed by the top wall outer edge 146 abuts against the inner surface 50 of the basin sidewall 48 along the rear 132 of the sidewall 48 adjacent or along the top edge 104 of the sidewall 48 helping not just to properly locate the cover 34 but also to help keep it from moving rearwardly.

As is best shown in FIGS. 5 and 8, part of the top wall 138 of the cover 34 can abut against a part of the pump power cord 90 cantilevered outwardly from the cord seat 106 of the cord strain relief 98 into the basin 32 that provides a cover rest 152. The cover rest 152 is formed by part of the cord 90 that extends from the cord seat 106 inwardly into the basin 32 generally perpendicular to an adjacent portion of the inner surface 50 of the basin sidewall 48 providing a generally flat portion of the cord 90 extending generally parallel to the cover top wall 138 upon which the top wall 138 of the cover 34 can rest or stop on when the cover 34 is attached to the pump 36. When the cover 34 is attached, a bottom portion of the outer edge 146 of the top wall 138 of the cover 34 can rest on or stop against the cover rest 152, part of the inner surface 114 of the cover top wall 138 can rest on or stop against the cover rest 152, and/or a bottom portion of the lip 148 can rest on or stop against the rest 152.

The cover rest 152 provided by part of the power cord 90 functions as a support underlying part of the cover 34 that helps structurally support part of the top wall 138 of the cover 34. In doing so, the cover rest 152 helps to prevent the top wall 138 from deflecting or otherwise moving toward the basin bottom 40, such as when a pet jumps on the cover 34. The cover rest 152 also helps locate the cover 34 by helping to set and maintain the height of the top wall 138 of the cover 34 relative to the basin 32. In this regard, the cover rest 152 helps locate the cover 34 when part of the top wall 138 lies on the rest 152 by helping to position the top wall 138 relative to the top edge 104 of an adjacent part of the basin sidewall 48. In the preferred fountain embodiment shown in the drawings, the cover rest 152 locates the top wall 138 of the cover 34 such that the top wall 138 is either substantially flush with the top edge 104 of an adjacent portion of the basin sidewall 48 or generally parallel to the basin sidewall top edge 104.

As is best shown in FIG. 5, when the cover 34 is mounted by the pump 36 to the basin 32, the cover 34 covers the pump 36 forming a pump enclosure 154 with the basin 32 also defining a pumping chamber 156 therebetween in which the pump 36 is disposed. With continued reference to FIG. 5, the top wall 138 of the cover 34 overlies the pump 36, with the spillway 136 extending downwardly in front of the pump intake 86 toward the basin bottom 40 dividing the basin 32 into the open drinking well 134 on one side of the spillway 136 and a water holding sump 158 on the other side of the spillway 136.

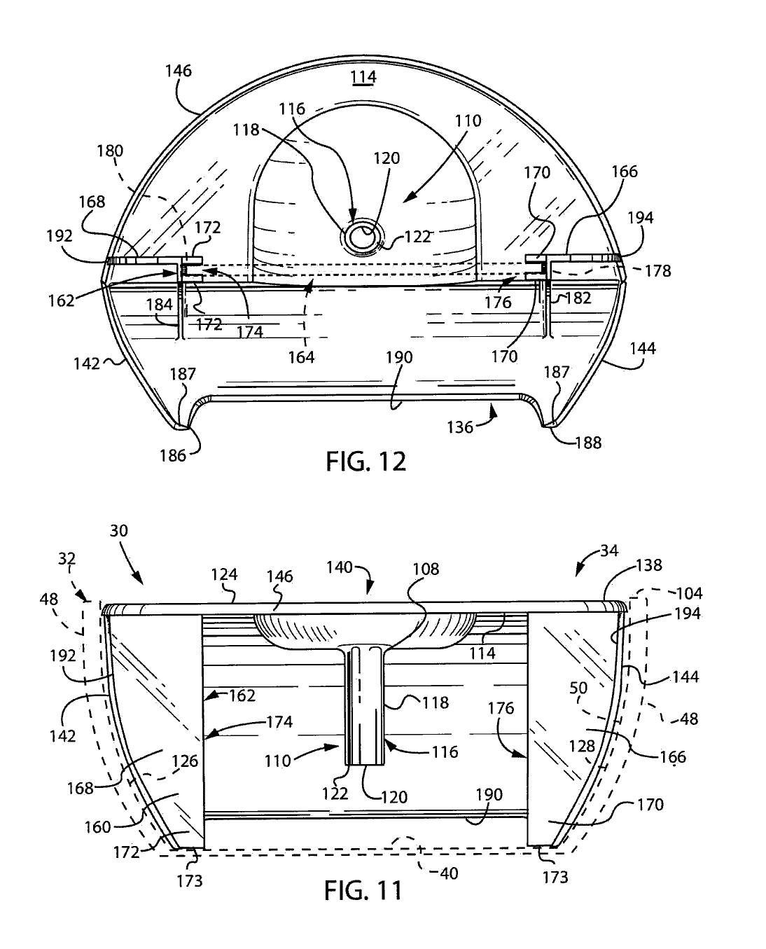

With additional reference to FIGS. 11-14, the cover 34 includes an integrally formed cover support 160 extending downwardly toward the basin bottom 40 between the pump 36 and spillway 136 upon which the cover 34 rests on the basin bottom 40 when attached to the basin 32 by the pump 36. The cover support 160 preferably is a wall that includes an integrally formed filter holder 162 that removably holds a replaceable water filter 164 that filters water 54 before it enters the intake 86 of the pump 36 during fountain operation. The filter holder 162 divides the cover support wall 160 into two wall sections 166, 168 that can respectively define legs 170, 172 upon which the cover 34 rests on the basin bottom 40.

The filter holder 162 is formed by a pair of generally vertically extending, parallel and opposed U-shaped channels 174, 176 which slidably receive a corresponding outer side edge 178, 180 of the filter 164, such as in the manner depicted in phantom in FIG. 12. In the preferred cover embodiment shown in the drawings, each filter holding channel 174, 176 defines a respective leg 170, 172 upon which the end of each leg 170, 172 rests on the basin bottom 40 when the cover 34 is attached to the pump 36. The filter 164 can be generally rectangular, e.g., square, having a frame which carries a perforate, granular, fibrous or other type of filter media. Such a filter 164 can also include activated charcoal or activated carbon if desired.

As is best shown in FIGS. 4, 11 and 12, the cover support wall 160 has a pair of outer side edges 192, 194 with one side edge 192 extending along part of one side 126 of the basin sidewall 48 downwardly toward the basin bottom 40 and the other side edge 194 extending along part of the other side 128 of the basin sidewall 48 downwardly toward the basin bottom 40. Where the cover support wall 160 is of a divided wall configuration, one outer side edge 192 defines the outer side edge of one support wall section 168 and the outer side edge 194 defines the outer side edge of the other support wall section 166. Each support wall section 166, 168 respectively defines a leg 170, 172 that terminates in a foot 173 that rests upon the basin bottom 40.

The cover 34 can also include a pair of spaced apart sections of webbing 182, 184 integrally formed of the cover 34 that interconnect a corresponding cover support wall section 166, 168 with the spillway 136 helping to stiffen and strengthen the cover 34. The spillway 136 extends downwardly from the top wall 138 of the cover 34 toward the basin bottom 40 resting on the bottom 40 on feet 187 of a pair of legs 186, 188 spaced apart by a bottom edge 190 of the spillway 136 extending between legs 186, 188 that is spaced above the basin bottom 40 defining a sump intake 191 therebetween.

Each outer side edge 142, 144 of the spillway 136 terminates at the basin bottom 40 helping to define a corresponding outer edge of a respective leg 186, 188 that extends downwardly to the bottom 40. Each outer spillway side edge 142, 144 extends from the free end of a corresponding leg 186, 188, where its foot 187 rests on the bottom 40, along the concavely curved inner surface 50 of a corresponding basin sidewall side 126, 128 adjoining each side 126, 128 of the basin sidewall 48 in a manner that prevents water 54 from passing therebetween during fountain operation. Such a construction helps ensure water 54 in the drinking well 134 is directed into the sump intake 191 and through the filter 164 during fountain operation. Such a construction also helps prevent side-to-side motion of the cover 34 in the basin 32 when attached to the pump 36.

The sump intake 191 is disposed generally in-line with the intake 86 of the pump 36 enabling water 54 in the drinking well 134 to flow through the intake 191 toward the pump intake 86 during recirculating fountain operation. Where the fountain 30 is equipped with a filter 164, the support wall 160 positions the filter 164 between the sump intake 191 and pump intake 86 so water 54 flowing through the sump intake 191 into the sump 158 passes through the filter 164 before being drawn in through the pump intake 86 into the pump 36. Such an in-line configuration means water 54 flows in a substantially straight line through the sump intake 191, through the filter 164, and into the pump intake 86 helping to optimize fountain operating efficiency.

As previously indicated, the spillway 136 extends from one side 126 of the basin sidewall 48 to the other side 128 of the basin sidewall 48 helping to prevent side-to-side movement of the cover 34 relative to the basin 32 when the cover 34 is seated in the basin 32. In addition to helping prevent side-to-side movement, extension of the spillway 136 from one side 126 of the basin sidewall 48 to the other side 128 of the basin sidewall 48 also helps locate the cover 34 in the basin 32 and helps support the cover 34 in the basin 32. As is best shown in FIG. 10, the outer side edges 142, 144 of the spillway 136 each define a curved abutment that can abut against an adjacent portion of the inner surface of a corresponding side 126, 128 of the basin sidewall 48 helping prevent side-to-side cover movement while also locating the cover 34 in an axis or plane extending through the pump 36, filter 164, and sump intake 191 of the spillway 136 in a longitudinal direction of the fountain 30.

As also discussed above, the cover support wall 160 extends from one side 126 of the basin sidewall 48 to the other side 128 of the basin sidewall 48 between the pump 36 and the spillway 136 also helping to prevent side-to-side movement of the cover 34 relative to the basin 32 when the cover 34 is seated in the basin 32. In addition to helping prevent side-to-side movement, extension of the cover support wall 160 from one side 126 of the basin sidewall 48 to the other side 128 of the basin sidewall 48 also helps locate the cover 34 in the basin 32 and helps support the cover 34 in the basin 32. As is best shown in FIG. 11, the outer side edges 192, 194 of the cover support wall 160 each define a curved abutment that can abut against an adjacent portion of the inner surface of a corresponding side 126, 128 of the basin sidewall 48 helping prevent side-to-side cover movement while also locating the cover 34 in the same axis or plane extending through the pump 36, filter 164, and sump intake 191 of the spillway 136 in a longitudinal direction of the fountain 30.

Where the basin 32 is oval as shown, the width of the spillway 136 from one side edge 142 to its opposite side edge 144 is greater than the width of the cover support wall 160 as defined by the distance from one side edge 192 to its opposite side edge 194. Where the inner surface of the oval sidewall 48 has substantially the same curvature along each side 126, 128 of the sidewall 48, side edges 142, 192 disposed along one sidewall side 126 and side edges 144, 194 disposed along the opposite sidewall side 128 have substantially the same curvature so as to be substantially complementarily curved to conform to the inner surface of the respective sidewall side 126, 128 against which the side edge abuts or can abut when the cover 34 is mounted to the pump 36 and seated in the basin 32.

When the cover 34 is mounted to the pump 36 in the manner described above, the cover support wall 160 rests by its legs 170, 172 on its feet 173 on the basin bottom 40 forming a moment about the location where the cover 34 attaches to the pump 36. When the cover 34 is mounted to the pump 36 in the manner described above, the spillway 136 also rests by its legs 186, 188 on its feet 187 forming a second moment about the location where the cover 34 attaches to the pump 36. These counteracting moments defined by the pair of spaced apart basin-bottom resting supports respectively provided by the cover support wall 160 and spillway 136 not only help to more securely and stably seat the cover 34 in the basin 32, they do so without any interlocking engagement between the cover 34 and basin 32.

In assembly, the pump 36 is mounted to the basin 32 by inserting the pump 36 into the pump seat 52 in the basin 32. The pump power cord 90 is manipulated, such as depicted in FIG. 7, so the cord 90 is inserted sideways into the mouth 102 of the T-shaped slot 100 of the cord strain relief 98 and then urged down into the slot 100 until the cord 90 is twisted into place in the generally horizontally extending cord seat 106. When attached to the basin 32, part of the cord 90 sticking out from the seat 106 extends generally horizontally into the basin 32 defining the cover rest 152.

The cover 34 is manipulated so its water transport tube 116 telescopes over the discharge tube 84 of the pump 36 seated in the pump seat 52 anchoring the cover 34 in the basin 32 via its attachment to the pump 36. As the water transport tube 116 of the cover 34 telescopes over the pump discharge tube 84, the outer edges 142, 144 of the spillway 136 slidably contact the inner surface 50 of a respective side 126, 128 of the basin sidewall 48 until the curved contour of each edge 142, 144 adjoins the respective side 126, 128 of the sidewall 48. This not only helps to provide side-to-side location of the cover 34 relative to sides 126, 128 of the basin sidewall 48 during cover assembly, it also helps prevent side-to-side movement of the cover 34 within the basin 32 when attachment of the cover 34 is completed.

As the water transport tube 116 of the cover 34 telescopes over the pump discharge tube 84, the feet 187 at the end of each leg 186, 188 of the spillway 136 come to rest on the bottom 40 of the basin 32 thereby helping to support the cover 34 on the basin 32 without interlockingly engaging the basin 32. When the spillway legs 186, 188 come to rest on the basin bottom 40, the upraised bottom edge 190 of the spillway 136 extending between the legs 186, 188 defines the sump intake 191 together with the portion of the bottom 40 underlying the bottom spillway edge 190.

As the water transport tube 116 of the cover 34 telescopes over the pump discharge tube 84, the legs 170, 172 of the cover support wall 160 behind the spillway 136 come to rest on part of the basin bottom 40 underlying the cover 34. The opposite outer edges 192, 194 of the support wall 160 slidably adjoin alongside the inner surface 50 of the basin sidewall 48 at opposite sides 126, 128 of the sidewall 48, such as depicted in FIG. 11, further helping to locate the cover 34 in the basin 32 as well as help prevent side-to-side motion of the cover 34 relative to the basin 32. Where the cover support wall 160 is configured to removably receive a filter 164, the filter 164 preferably is attached to the cover 34 before the cover 34 is mounted to the pump 36. When attachment of the cover 34 is completed, the cover support wall 160 rests on the basin bottom 40 helping to not only locate the cover 34 in the basin 32 but also structurally supporting the cover 34 within the basin 32. When attachment of the cover 34 is completed, the outer edges 192, 194 of the cover support wall 160 abut against part of the inner surface 50 of an adjacent side 126, 128 of the basin sidewall 48 helping to locate the cover 34 in the basin 32 and helping to prevent side-to-side cover movement.

As the water transport tube 116 of the cover 34 telescopes over the pump discharge tube 84, the cover locator 150 of the cover top wall 138 slidably contacts the inner surface 50 of the basin sidewall 48 along the rear 132 of the basin 32 helping to locate the part of the cover 34 opposite the spillway 136 relative to the basin 32. In addition, part of the cover top wall 138 ends up overlying the power cord-defined cover rest 152 helping to not only locate the top wall 138 of the cover 34 relative to the top edge 104 of the basin sidewall 48, part of the top wall 138 can be supported on the rest 152 helping to hold the top wall 138 in place.

During operation, the pump 36 draws water 54 in the sump 158 through its intake 86 where the water 54 is pumped through the water transport tube 116 out the outlet opening 108 in the cover 34. Where the cover 34 includes an upper drinking bowl 140, water 54 exiting the outlet opening 108 pools in the bowl 140 before overflowing down the spillway 136 into the open drinking well 134 below. As is best shown in FIG. 1, water 54 flows down the center of the spillway 136 toward the opposite end 130 of the basin 32 where the curved basin sidewall 48 can split the flow so water 54 flows in the well 134 around respective opposite sides 126, 128 of the sidewall 138 back toward the spillway 136. Each return flow of water 54 back toward the spillway 136 flows on opposite sides of the water flowing down the spillway 136 into the drinking well 134. Such a flow pattern advantageously helps keep at least a central portion of the sump intake 191 clear of debris during fountain operation.

Water 54 in the open drinking well 134 flows back toward the spillway 136 where it enters the sump intake 191 and flows into the sump 158 toward the filter 164. Water 54 passes through the filter 164 before entering the pumping chamber 156 where it is drawn through the pump intake 86 into the pump 36 recirculating water 54 in the fountain 30 by pumping the water 54 back up to the cover 34. As water 54 passes through the filter 164 debris and other matter are trapped by the filter 164 such that water 54 substantially free of debris and matter enters the pump 36.

A recirculating pet fountain 30 constructed in accordance with the present invention has a basin 32 and cover 34 preferably made of a dishwasher safe material that can be a plastic, such as polypropylene, polyethylene, or the like, a metal, such as a stainless steel, or another suitable material, such as a ceramic material. A recirculating pet fountain 30 constructed in accordance with the present invention is of simple construction that can be and preferably is formed in at least one recirculating pet fountain embodiment of a minimum of components: a basin 32, a cover 34, and a pump 36 where the cover 34 is anchored in the basin 32 solely by attachment to the pump 36 with the pump 36 attached to the basin 32 by being mounted in the basin 32. Such a recirculating pet fountain 30 formed of a minimum of components advantageously is not just of economical construction but is also more reliable, easier and quicker to assembly, easier to clean, and can operate longer before requiring disassembly and cleaning.

Understandably, the present invention has been described above in terms of one or more preferred embodiments and methods. It is recognized that various alternatives and modifications may be made to these embodiments and methods that are within the scope of the present invention. Various alternatives are contemplated as being within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

What is claimed is:

1. A recirculating pet fountain comprising:
a basin having a bottom and sidewall extending upwardly therefrom;
a pump; and
a cover.

2. The pet fountain of claim 1 wherein the cover overlies the pump and comprises a spillway extending downwardly to a bottom of the basin having a pair of spaced apart feet that rest on the bottom and a bottom edge spaced from the bottom defining an intake therebetween in liquid flow communication with the pump.

3. The pet fountain of claim 2 wherein the cover further comprises a support extending downwardly from the cover that rests on the bottom of the basin.

4. The pet fountain of claim 3 wherein the support further comprises a wall disposed between the pump and the spillway.

5. The pet fountain of claim 4 wherein the support wall comprises a filter holder removably holding a water filter disposed between the intake and the pump.

6. The pet fountain of claim 2 wherein the spillway is inclined at an acute included angle with the bottom of the basin, wherein one of the feet of the spillway adjoins the sidewall of the basin on one side of the basin and the other one of the feet of the spillway adjoins the sidewall of the basin on the other side of the basin, and wherein the bottom edge extends between the feet.

7. The pet fountain of claim 6 wherein the spillway extends from one side of the basin sidewall to the other side of the basin sidewall.

8. The pet fountain of claim 7 wherein the spillway has a pair of side edges extending along and adjoining an inner surface of a corresponding side of the basin sidewall preventing side-to-side movement of the cover relative to the basin.

9. The pet fountain of claim 1 wherein the basin comprises a cord strain relief, wherein the pump has an electrical power cord releasably anchored to the cord strain relief, and wherein part of the cord extending outwardly from the cord strain relief in the basin comprises a rest upon which part of the cover is supported.

10. The pet fountain of claim 9 wherein the cord strain relief comprises a slot in the basin sidewall in which part of the power cord is received and wherein the cover rest comprises part of the cord extending generally horizontally from the basin sidewall into the basin and wherein a generally horizontally extending part of the cover rests on the cover rest.

11. The pet fountain of claim 1 wherein the pump is seated in the basin and wherein the cover is anchored in the basin solely by attachment of the cover to the pump.

12. The pet fountain of claim 11 wherein the pump has a discharge tube from which water is discharged by the pump and wherein the cover has a water transport tube telescopically coupling with the pump discharge tube attaching the cover to the pump anchoring the cover in the basin.

13. The pet fountain of claim 12 wherein the basin sidewall has a cord anchor slot formed therein and wherein the pump has an electrical power cord received in the slot with part of the cord extending outwardly from the basin sidewall into the basin comprising a cover rest underlying and supporting part of the cover thereon when the cover is attached to the pump.

14. The pet fountain of claim 13 wherein the cover further comprises a spillway extending downwardly toward the basin bottom down which water pumped from the pump through the water transport tube flows and wherein the spillway is disposed on one side of the pump and the cover support is disposed on the other side of the pump.

15. The pet fountain of claim 14 wherein the cover further comprises a filter holder extending downwardly toward the basin bottom removably receiving a filter therein wherein the filter holder is disposed between the spillway and the pump.

16. The pet fountain of claim 15 wherein one of the filter holder and the spillway rests on the bottom of the basin supporting the cover thereon.

17. The pet fountain of claim 16 wherein the filter holder and the spillway both rest on the bottom of the basin.

18. A recirculating pet fountain comprising:
a basin having a bottom and sidewall extending upwardly therefrom;
a pump attached to the basin, the pump having a discharge tube; and
a cover having a water transport tube fluid coupled to the discharge tube of the pump attaching the cover to the pump anchoring the cover in the basin, the cover comprising a spillway extending toward the bottom of the basin down which water from the pump discharged through the water transport tube flows into an open drinking well between the cover and the basin, and the cover comprising a filter holder extending downwardly from the cover toward the bottom of the basin between the pump and spillway with the filter holder releasably holding a filter that filters water from the open drinking well before entering the pump.

19. The pet fountain of claim 18 wherein the spillway rests on the basin bottom supporting the cover thereon.

20. The pet fountain of claim 18 wherein the filter holder rests on the basin bottom supporting the cover thereon.

21. The pet fountain of claim 18 wherein the cover is anchored in the basin solely by attachment to the pump.

22. The pet fountain of claim 21 wherein the spillway and filter holder both rest on the basin bottom supporting the cover thereon.

23. A recirculating pet fountain comprising:
a basin having a bottom and sidewall extending upwardly therefrom;
a pump attached to the basin; and
a cover in liquid flow communication with the pump, the cover comprising a spillway extending downwardly toward the basin bottom down which water from the pump flows into an open drinking well formed between the cover and basin, the spillway defining an intake with the basin bottom in liquid flow communication with the pump, and the cover comprising a filter holder extending downwardly toward the basin bottom removably holding a filter disposed between the pump and the intake.
